(19) United States
(12) Patent Application Publication
(10) Pub. No.: US 2005/0147944 A1
(43) Pub. Date: Jul. 7, 2005

(54) Curable dental mill blanks and related methods

(76) Inventors: Naimul Karim, Maplewood, MN (US); Oswald Gasser, Seefeld (DE)

Correspondence Address: 3M INNOVATIVE PROPERTIES COMPANY, PO BOX 33427, ST. PAUL, MN, 55133-3427, US

(21) Appl. No.: 10/749,306

(22) Filed: Dec. 31, 2003

(51) Int. Cl. A61C 13/00

(52) U.S. Cl. 433/201.1; 264/16

(57) ABSTRACT

The invention features a dental mill blank constructed from an uncured, self-supporting, hardenable organic composition. The invention also provides a method of making a dental appliance. The method involves machining an uncured dental mill blank into an uncured shaped article and then at least partially curing the shaped article. The shaped article may be cured in multiple steps with or without additional machining steps in between the curing steps.

### FIELD OF THE INVENTION

The invention relates to curable dental mill blanks that are suitable for use in fabricating dental and orthodontic appliances by machining procedures.

### BACKGROUND OF THE INVENTION

Custom-fit dental prosthetics (i.e., prostheses) are often used as replacements for tooth structures. Examples of common dental prosthetics include restoratives, replacements, inlays, onlays, veneers, full and partial crowns, bridges, implants, posts, and the like. Currently, most prostheses in dentistry are either made by hand by a dental practitioner or by a dental laboratory having specialized equipment capable of such fabrication.

Materials used to make dental prostheses typically include gold, ceramics, amalgam, porcelain, and composites. For dental restorative work such as fillings, amalgam is a popular choice for its long life and low cost. Amalgam also provides a dental practitioner the capability of fitting and fabricating a dental filling during a single session with a patient. The aesthetic value of amalgam, however, is quite low, as its color drastically contrasts to that of natural teeth. For large inlays and fillings, gold is often used. However, similar to amalgam, gold fillings contrast to natural tooth colors. Thus, dental practitioners are increasingly turning to ceramic or polymer-ceramic composite materials because the color of these materials can be more closely matched with that of natural teeth.

The conventional procedure for producing dental prosthetics by hand typically requires the patient to have at least two sessions with the dentist. First, an impression is taken of the dentition using an elastomeric material from which a cast model is made to replicate the dentition. The prosthetic is then produced from the model using metal, ceramic or a composite material. A series of steps for proper fit and comfort then follows. This fabrication process is lengthy (1-2 days), labor intensive, and requires a high degree of skill and craftsmanship. Alternatively, a practitioner may opt for a sintered metal system that may be faster; however, such procedures are still labor intensive and quite complex.

In recent years, technological advances have provided computer automated machinery capable of fabricating prostheses using minimal human labor and drastically lower work time. This technology, in which computer automation is combined with optics, digitizing equipment, CAD/CAM (computer-aided design/computer aided machining) and mechanical milling tools, is frequently referred to as “digital dentistry.” Such computerized machining processes produce dental prostheses by cutting, milling, and grinding the near-exact shape and morphology of a required restorative with greater speed and lower labor requirements than conventional hand-made procedures.

Fabrication of dental prostheses using a CAD/CAM device typically involves use of a “mill blank,” a solid block of material from which the prosthetic is cut or carved. The mill blank is typically made of ceramic material. There exist various mill blanks available commercially, including VITA CELAY® porcelain blanks Vita Mark II Vitablocks® and VITA IN-CERAM® ceramic blanks (available from Vita Zahn Fabrik; Bad Sackingen, Germany). Machinable micaceous ceramic blanks (e.g. Coming MACOR® blanks and Dentsply DICOR® blanks) are also commercially available.

### SUMMARY OF THE INVENTION

A disadvantage arising from machining ceramic mill blanks is that these materials are very hard, which results in long machining times and a high degree of wear on the tool. The cost of machining such blanks is therefore very high.

The present invention features a dental mill blank comprising a substantially uncured, self-supporting, hardenable organic composition. (The dental mill blank is also referred to herein as “mill blank”, “uncured mill blank”, and “uncured dental mill blank”.) Typically, the mill blank is made of a wax-like, composite material that has sufficient hardness at room temperature to be milled. Since the mill blank of the invention is constructed of an uncured material, it is generally softer than ceramic mill blanks or mill blanks made of a hardened composite. Thus, by using mill blanks made of an uncured, organic composition for fabrication of dental appliances, the machining tools used for milling the blanks are subject to less wear, which results in tools having a longer service life and in considerably reduced costs. In addition, dental appliances may be fabricated with faster machining times.

The dental mill blanks of the invention may be made of a variety of hardenable or polymerizable materials, including an uncured composite material. In one embodiment, the mill blank comprises a polymerizable resin system, an optional filler system, and an initiator system. The mill blank may also include one or more viscosity modifiers and/or a surfactant system.

The polymerizable resin system may comprise a crystalline component, which may include, for example, one or more polyester, polyether, polyolefin, polythioether, polyarylalkylene, polysilane, polyamide, polyurethane, or combinations thereof. Alternatively, the crystalline component may be a non-polymeric material. The crystalline component can optionally have a dendritic, hyperbranched, or star-shaped structure.

If desired, the crystalline component can include one or more reactive groups to provide sites for polymerizing and/or crosslinking. Typically, the crystalline component comprises saturated, linear, aliphatic polyester polyols containing primary hydroxyl end groups wherein the hydroxyl end groups are modified to introduce polymerizable unsaturated functional groups.

If such crystalline components are not present or do not include reactive groups, such reactive sites may be provided by another resin component, such as an ethylenically unsaturated component. Thus, for certain embodiments, the resin system includes at least one ethylenically unsaturated component. Ethylenically unsaturated components may be selected from the group consisting of mono-, di-, or poly-acrylates and methacrylates, unsaturated amides, vinyl compounds (including vinyl oxy compounds), and combinations thereof. This ethylenically unsaturated component can be the crystalline component, although in certain preferred embodiments it is noncrystalline.

Typically, the total amount of the resin system is between about 10 wt-% and about 100 wt-%, more typically between about 20% and 90%, and even more typically between about 40% and about 70%.

Fillers for use in the filler system may be selected from a wide variety of conventional fillers for incorporation into resin systems. Typically, the filler system includes one or more conventional materials suitable for use in compositions used for medical applications, for example, fillers currently used in dental restorative compositions. Thus, the filler systems used in the compositions of the present invention are incorporated into the resin systems, and are generally mixed with the crystalline component of the resin system.

Fillers may be either particulate or fibrous in nature. Typically, at least a portion of the filler system comprises particulate filler, which may generally be defined as having a length to width ratio, or aspect ratio, of 20:1 or less, and more commonly 10:1 or less. If the filler system includes fibers, the fibers are generally present in an amount of less than 20 wt-%, based on the total weight of the composition. In one embodiment, the filler system comprises an inorganic material comprising nanoscopic particles (i.e. particles having an average primary diameter of less than 200 nm).

The initiator system typically includes one or more initiators suitable for hardening (e.g., polymerizing and/or crosslinking) of the resin system. The initiators are preferably free radical initiators, which may be activated in a variety of ways, e.g., heat and/or radiation. Preferably, the initiator system includes one or more photoinitiators.

In another aspect, the invention provides a method of making a dental appliance, which method comprises machining a substantially uncured dental mill blank into an uncured shaped article and then at least partially curing the shaped article to provide a hardened dental appliance. The shaped article may be cured in multiple steps with or without additional machining steps in between the curing steps. Subsequent curing steps may optionally be performed under different conditions than the initial curing step. For example, subsequent curing steps may differ from the initial curing step in terms of mode of initiation, i.e. photo vs. thermal; or in terms of temperature and pressure at which cure takes place (e.g. in an autoclave); or in terms of environment, e.g. in an oxygen deficient environment, etc.

In some embodiments, the method may further include a step of processing the hardened dental appliance. Such processing may include, for example, surface treating, trimming, polishing, coating, priming, staining, or glazing the hardened dental appliance.

In yet another embodiment, the machining step(s) comprise milling the dental mill blank using computer controlled milling equipment, such as, for example, a CAD/CAM device.

The dental mill blanks and related methods of the invention can be used in the fabrication of a variety of dental appliances, including, for example, dental restoratives and dental prostheses, such as crowns and bridges, inlays, onlays, veneers, implants, implant support structures, dentures, and artificial teeth, as well as dental impression trays, orthodontic appliances (e.g., a retainer, a night guard, a bracket, a buccal tube, a band, a cleat, a button, a lingual retainer, a bite opener, a positioner, and the like), tooth facsimiles or splints, maxillofacial prosthesis, and other customized structures.

By using the dental mill blanks and related methods of the invention, it is possible to fashion custom dental prosthetics in less time, with less wear on the machining tools, resulting in longer tool life and lower costs for machining. It is also possible to use a less expensive, smaller machine as well as less expensive cutting tools.

Other features and advantages of the present invention will be apparent from the following Detailed Description thereof, and from the claims.

### Definitions

By “self-supporting” is meant that the organic composition is dimensionally stable and will maintain its shape (e.g., a dental mill blank) without significant deformation at room temperature (i.e., about 20° C. to about 25° C.) for at least about two weeks when free-standing (i.e., without the support of packaging or a container). Typically, the compositions are dimensionally stable at room temperature for at least about one month, and more typically, for at least about six months. Preferably, the compositions are dimensionally stable at temperatures above room temperature, more preferably up to about 40° C., and even more preferably up to about 60° C. This definition applies in the absence of conditions that activate the initiator system and in the absence of an external force other than gravity. In one embodiment, the mill blanks of the invention are made of a composition that is “millable self-supporting”, by which is meant that the composition does not require a cure or partial cure in order to sustain the forces of milling or machining.

By “dental appliance” is meant any dental or orthodontic appliance, restoration, article, or prosthetic device. The appliance may be a finished appliance ready for introduction into the mouth of the patient, or it may be a preformed or near-final dental or orthodontic article that is subjected to further processing before use.

By “machining” is meant milling, cutting, carving, or shaping a material by machine.

By “milling” is meant abrading, polishing, controlled vaporization, electronic discharge milling (EDM), cutting by water jet or laser or any other method of cutting, removing, shaping or carving material.

By “dental mill blank” is meant a solid block of material from which a dental or orthodontic article or appliance can be cut, carved, or milled.

By “composite material” is meant a hardenable (or hardened) composition containing at least in part, a polymerizable (or polymerized) resin(s), filler particles of one or more types, a polymerization initiator, and any desired adjuvants. Composite materials for use in the present invention are typically compositions where polymerization may be initiated by a variety of means including heat, light, radiation, e-beam, microwave, or chemical reaction.

By “resin system” is meant one or more hardenable resins, each of which can include one or more monomers, polymerizable oligomers, and/or polymerizable polymers. A resin system can include one or more crystalline components.

By “filler system” is meant one or more fillers suitable for use in a medical or dental composition.

By “initiator system” is meant one or more initiators suitable for hardening the resin system.

By “crystalline component” is meant that the component displays a crystalline melting point at 20° C. or above when measured in the composition by differential scanning calorimetry (DSC). The peak temperature of the observed endotherm is taken as the crystalline melting point. The crystalline phase includes multiple lattices in which the component assumes a conformation in which there is a highly ordered registry in adjacent chemical moieties of which the component is constructed. The packing arrangement (short order orientation) within the lattice is highly regular in both its chemical and geometric aspects. The crystalline component can be polymeric or non-polymeric and can be polymerizable or non-polymerizable. Typically, a crystalline component is considered to be non-polymeric if it has a molecular weight of less than 10,000, and more typically less than 5,000.

By “curing” is meant hardening or partial hardening of an article (e.g. an article comprising a hardenable composition) by any mechanism, e.g., by heat, light, radiation, e-beam, microwave, chemical reaction, or combinations thereof. The term “substantially uncured” means that the composition has been cured to an extent of less than 10%, typically less than 5%, and more typically less than 1% whether by incidental or intentional curing mechanisms. The extent of cure can be measured by standard, well-known techniques, such as, for example, by IR microscopy, FTIR, or measurement of physical effects, such as hardness, rheology, etc. Preferably, the extent of cure is measured by determining the percentage of crosslinking moieties that are reacted, as measured by, e.g., FTIR.

### DETAILED DESCRIPTION

The present invention provides an uncured dental mill blank that is useful for fabricating dental appliances. The uncured mill blank typically has a solid, wax-like consistency at ambient temperature and has sufficient structural and mechanical integrity to maintain its dimensional stability during storage, shipment, handling and various processing steps.

The dental mill blank of the invention can be made from the class of dental compositions described by Karim et al., WO 03/015720 (“Hardenable Self-Supporting Structures and Methods”), which is incorporated by reference herein in its entirety. These compositions generally include an uncured, hardenable resin system; an optional filler system that may include fibers and nanoscopic fillers; an initiator system; and optionally, viscosity modifiers and/or a surfactant system.

Alternatively, the dental mill blanks can be made from other wax-like composite materials, such as the class of dental composites described in WO 02/26197 A2 (“Wax-Like Polymerizable Dental Material, Method, and Shaped Product”); U.S. Pat. No. 5,403,188 (“Dental Crowns and Bridges From Semi-Thermoplastic Molding Compositions Having Heat-Stable Custom Shape Memory”); U.S. Pat. No. 6,057,383 (“Dental Material Based on Polymerizable Waxes”), each of which is incorporated herein in its entirety.

Typically, the elastic dynamic modulus of the mill blanks varies over a wide range. Furthermore, the mill blanks are typically free from tack. Preferably, the elastic dynamic modulus (i.e., elastic modulus) G′ at room temperature, as measured by a Rheometrics RDA II dynamic mechanical analyzer (Rheometric Scientific, Piscataway, N.J.) is at least about 200 kilopascals (kPa), more preferably, at least about 500 kPa, and most preferably at least about 1000 kPa, at a frequency of about 0.005 Hz. Test methods for measuring the dynamic modulus are described in, for example, WO 03/015720, which is herein incorporated by reference.

The mill blanks of the present invention may comprise optional additives suitable for use in the oral environment, including colorants, flavorants, anti-microbials, fragrance, stabilizers, and viscosity modifiers. Other suitable optional additives include agents that impart fluorescence and/or opalescence.

Blanks of composite material may be made in any desired shape or size, including cylinders, bars, cubes, polyhedra, ovoids, and plates. The composition for a mill blank can be blended in a variety of ways, like in a speed mixer (as described in, for example, WO 03/015720), in a sigma blade mixer, in a planetary mixer, etc. The mill blank itself can be made from this blended composition also in a variety of ways, like molding, injection molding, compression molding, thermoforming, pressing, calendering, etc.

The uncured mill blank of the invention can be machined easily by a variety of reductive processes to obtain a net shape or a near net shape of a dental appliance. Reductive processes include milling, cutting, skiving, sharpening, lathing, abrading, sanding, etc. The net shaped or the near net shaped article is subsequently hardened (by hardening the resin system in the composition) to obtain a finished dental appliance.

Various means of milling the mill blanks of the present invention may be employed to create custom-fit dental prosthetics and other appliances having a desired shape and morphology. While milling the blank by hand using a hand-held tool or instrument is possible, preferably the prosthetic is milled by machine, including the use of power machines, electrically powered machines, and computer controlled milling equipment. A preferred device to create a prosthetic and achieve the full benefits of the composite material of the present invention is to use a CAD/CAM device capable of milling a blank. Examples of such a computer-aided milling machine include the CEREC 2® machine supplied by Siemens (available from Sirona Dental Systems; Bensheim, Germany); VITA CELAY®, (available from Vita Zahn Fabrik; Bad Sackingen, Germany); PRO-CAM® (Intra-Tech Dental Products, Dallas, Tex.); and PROCERA ALLCERAM® (available from Nobel Biocare USA, Inc.; Westmont, Ill.). U.S. Pat. No. 4,837,732 (Brandestini et al.), and U.S. Pat. No. 4,575,805 (Moermann et al.) also disclose the technology of computer-aided milling machines for making dental prostheses.

By using a CAD/CAM milling device, the prosthetic can be fabricated efficiently and with precision. During milling, the contact area may be dry, or it may be flushed with a lubricant. Alternatively, it may be flushed with an air or gas stream. Suitable lubricants are well known in the art, and include water, oils, glycerine, ethylene glycols, and silicones. In certain methods utilizing a CAD/CAM milling device, the electronic image of the shaped article to be fabricated by machining is enlarged in order to compensate or at least partially compensate for the shrinkage of the article that will occur during the subsequent curing step.

After machine milling the mill blank, the net shape or near net shape article is cured to produce a hardened dental appliance. Curing may be performed in one step or there may be multiple curing steps. When multiple curing steps are performed, it may be desirable to perform additional machining steps in between the curing step to further shape and mill the article. One or more of the curing steps may be performed under controlled environments of defined ranges of temperature, pressure, electromagnetic radiation, etc. These parameters may be varied between the different curing or hardening steps as desired. The appropriate curing method will depend on the initiator system used in the mill blank.

Once the curing process is completed and a hardened dental appliance has been produced, one or more additional processing steps may be performed after the hardening step. This may include any of a variety of surface treatments or other processing steps, including trimming, polishing, coating, priming, staining, glazing, and the like. Similarly, as discussed above, hardening can be carried out in multiple steps, with certain processing steps being performed in between. Machining of the uncured mill blank may also include “forming” methods, like pressing, molding, etc. (optionally in combination with heating), followed by hardening.

A variety of dental appliances may be fabricated from the uncured mill blanks. Examples include, but are not limited to, orthodontic appliances, bridges, crowns, space maintainers, tooth replacement appliances, dentures, posts, jackets, inlays, onlays, veneers, facings, facets, abutments, implants, implant support structures, and splints.

A dental prosthetic produced in accordance with the present invention can be attached to the tooth or bone structure with conventional cements or adhesives or other appropriate means such as glass ionomers, resin cements, zinc phosphates, zinc polycarboxylates, compomers, or resin-modified glass. In addition, material can optionally be added to the milled prosthetic for various purposes including repair, correction, or enhancing esthetics. The additional material may be of one or more different shades or colors. The added material may be composite, ceramic, or metal.

An advantage of the present invention is that an uncured, wax-like mill blank is much faster and easier to machine than traditional cured composite mill blanks or ceramic mill blanks, and yet a dental appliance of high strength is still obtained after the fabricated article has been hardened. Less expensive tooling can be used to machine the softer, uncured mill blank. In addition, machining time is shorter, and thus the desired appliance can be fabricated faster and at a lower cost. Because of the above-mentioned advantages the mill blank of invention can also be used for preparation of temporaries or for mock-ups for various dental or orthodontic procedures, but may also be used for permanent prosthetic applications as well.

The above specification provides a description of dental mill blanks and methods of the invention. The invention is not limited to the embodiments disclosed herein. One skilled in the art will appreciate that many alternative embodiments of the invention can be made without departing from the spirit and scope thereof.

All patents, applications, and publications mentioned above are incorporated by reference herein.

1. A method of making a dental appliance, said method comprising:
(a) providing a dental mill blank comprising a substantially uncured, self-supporting, hardenable organic composition;
(b) machining the mill blank into an uncured shaped article; and
(c) at least partially curing the shaped article to provide a hardened dental appliance.

2. The method of claim 1, wherein the organic composition comprises a substantially uncured composite material.

3. The method of claim 2, wherein the composite material comprises a polymerizable resin system and an initiator system.

4. The method of claim 3, wherein the composite material further comprises a filler system.

5. The method of claim 4, wherein the polymerizable resin system comprises a crystalline component.

6. The method of claim 5, wherein the crystalline component is non-polymeric.

7. The method of claim 5, wherein the crystalline component comprises one or more polyester, polyether, polyolefin, polythioether, polyarylalkylene, polysilane, polyamide, polyurethane, or combinations thereof.

8. The method of claim 7, wherein the crystalline component comprises saturated, linear, aliphatic polyester polyols containing primary hydroxyl end groups.

9. The method of claim 8 wherein the hydroxyl end groups are modified to introduce polymerizable unsaturated functional groups.

10. The method of claim 5, wherein the crystalline component has a dendritic, hyperbranched, or star-shaped structure.

11. The method of claim 4, wherein the polymerizable resin system comprises at least one ethylenically unsaturated component.

12. The method of claim 11, wherein the ethylenically unsaturated component is selected from mono-, di-, or poly-acrylates and methacrylates, unsaturated amides, vinyl compounds, and combinations thereof.

13. The method of claim 4, wherein at least a portion of the filler system comprises particulate filler.

14. The method of claim 4, wherein the filler system comprises an inorganic material comprising nanoscopic particles.

15. The method of claim 4, wherein the initiator system comprises a free radical initiator.

16. The method of claim 4, wherein the initiator system comprises a photoinitiator or a thermal initiator.

17. The method of claim 4, wherein the mill blank further comprises a viscosity modifier.

18. The method of claim 4, wherein said mill blank further comprises a surfactant system.

19. The method of claim 1, wherein said dental appliance is a crown, an inlay, an onlay, a bridge, a veneer, an orthodontic appliance, a maxillofacial prosthesis, a tooth facsimile, or a tooth splint.

20. The method of claim 1, further comprising the step of processing the hardened dental appliance.

21. The method of claim 20, wherein the processing comprises surface treating, trimming, polishing, coating, priming, staining, or glazing the hardened dental appliance.

22. The method of claim 1, wherein said machining comprises milling the mill blank using computer-controlled milling equipment.

23. The method of claim 22, wherein the computer-controlled milling equipment comprises a CAD/CAM device.

24. The method of claim 1, wherein a second machining step is performed after said curing step.

25. The method of claim 24, wherein a second curing step is performed after said second machining step.

26. The method of claim 25, wherein said second curing step is performed under different conditions from the initial curing step.

27. A method of making a dental appliance, said method comprising:
(a) providing a dental mill blank comprising a substantially uncured, self-supporting, hardenable organic composition;
(b) machining the mill blank into a preformed article;
(c) partially curing the preformed article to provide a partially cured article;
(d) machining said partially cured article to form a shaped article; and
(e) at least partially curing said shaped article to provide a hardened dental appliance.

28. A dental mill blank comprising a substantially uncured, self-supporting hardenable organic composition.

29. The dental mill blank of claim 28, wherein the organic composition comprises a substantially uncured composite material.

30. The dental mill blank of claim 29, wherein the composite material comprises a polymerizable resin system and an initiator system.

31. The dental mill blank of claim 30, wherein the composite material further comprises a filler system.

32. The dental mill blank of claim 31, wherein the polymerizable resin system comprises a crystalline component.

33. The dental mill blank of claim 32, wherein the crystalline component is non-polymeric.

34. The dental mill blank of claim 32, wherein the crystalline component comprises one or more polyester, polyether, polyolefin, polythioether, polyarylalkylene, polysilane, polyamide, polyurethane, or combinations thereof.

35. The dental mill blank of claim 34, wherein the crystalline component comprises saturated, linear, aliphatic polyester polyols containing primary hydroxyl end groups.

36. The dental mill blank of claim 35, wherein the hydroxyl end groups are modified to introduce polymerizable unsaturated functional groups.

37. The dental mill blank of claim 32, wherein the crystalline component has a dendritic, hyperbranched, or star-shaped structure.

38. The dental mill blank of claim 31, wherein the polymerizable resin system comprises at least one ethylenically unsaturated component.

39. The dental mill blank of claim 38, wherein the ethylenically unsaturated component is selected from mono-, di-, or poly-acrylates and methacrylates, unsaturated amides, vinyl compounds, and combinations thereof.

40. The dental mill blank of claim 31, wherein at least a portion of the filler system comprises particulate filler.

41. The dental mill blank claim 31, wherein the filler system comprises an inorganic material comprising nanoscopic particles.

42. The dental mill blank of claim 31, wherein the initiator system comprises a free radical initiator.

43. The dental mill blank of claim 31, wherein the initiator system comprises a photoinitiator or a thermal initiator.

44. The dental mill blank of claim 31 further comprising a viscosity modifier.

45. The dental mill blank of claim 31 further comprising a surfactant system.
